(19) United States
(12) Patent Application Publication
(10) Pub. No.: US 2024/0202124 A1
(43) Pub. Date: Jun. 20, 2024

(54) SNOOP FILTER FOR LARGE CACHE USING HASH TECHNIQUE WITH OPTIMAL REFRESH ALGORITHM

(71) Applicant: Intel Corporation, Santa Clara, CA (US)

(72) Inventors: Israel Diamand, Aderet (IL); Randy Osborne, Beaverton, OR (US); Nadav Bonen, Ofer (IL)

(21) Appl. No.: 18/067,779

(22) Filed: Dec. 19, 2022

(51) Int. Cl. G06F 12/0831; G06F 12/0864

(52) U.S. Cl. CPC G06F 12/0831; G06F 12/0864

(57) ABSTRACT

Embodiments described herein may include apparatus, systems, techniques, and/or processes that are directed to computing systems implementing a very large cache for one or more processing engines in a shared memory system. According to various embodiments, a snoop filter tracks a hash value of the cached addresses instead of tracking the addresses themselves. Tracking hash values introduces inaccuracy and an inability to easily clean or refresh the snoop filter. A refresh algorithm maintains cache coherency without significant performance degradation. The cache refresh algorithm keeps the accuracy of the snoop filter, hence reducing the latency and power effects of false snoops. Further, the use of hash values reduces the hardware cost over traditional snoop filters.

### TECHNICAL FIELD

Embodiments of the present disclosure generally relate to the field of computing, in particular, maintaining cache coherency for a very large cache in a computing system with shared memory.

### BACKGROUND

Computing systems continue to increase in complexity, including multiple heterogeneous processing cores and a distributed shared memory (DSM). A DSM is a form of memory architecture where physically separated memories can be addressed as a single shared address space. There may not be a single centralized memory, but the address space is shared, that is, the same physical address on two processing cores or engines refers to the same location in memory. A cache may be a hardware or software component that stores data locally to a processing core so that future requests for that data can be retrieved faster. The data stored in a cache might be the result of an earlier computation or a copy of data stored elsewhere. A large cache increases the performance of the core and overall computing system. A processing core may have multiple levels of cache, further improving performance. A computing system may utilize a caching agent which maintains coherency from the core/device side. A home caching agent or simply home agent maintains cache coherency from the memory side, that is, maintains coherency among the various caching agents.

Cache coherence is the uniformity of shared data that ends up stored in multiple local caches. When clients or agents in a computing system maintain caches of a common memory resource, problems may arise with incoherent data, which is particularly the case with multiple processing cores in a multiprocessing system.

Without any additional functionality, the home agent sends a snoop request to a cache on any memory read/write from another agent. This causes a latency increase for any memory request, power waste for redundant snoop requests, and an increase of area to support high bandwidth snoop traffic, including more request and response busses.

A snoop filter may be used by a processing core to maintain cache coherency. A snoop filter monitors access by processing cores to the shared memory and includes snoop filter control logic and a snoop filter cache configured to maintain cache coherency. When specific data is shared by several caches and a core modifies the value of the shared data, the change must be propagated to all the other caches which have a copy of the data. The notification of data change can be done by bus snooping. All the snooper filters monitor every transaction on a bus. If a transaction modifying a shared cache block appears on a bus, all the snoop filters check whether their caches have the same copy of the shared block by checking for the address in their cache tag arrays. If a cache has a copy of the shared block, the corresponding snoop filter may perform a refresh of the data or invalidate the cache block.

While increasing cache sizes increases performance, it also introduces significant power, performance, and hardware costs for storing cache tags in the snoop filter and a need for complex cache coherency algorithms. The typical size of a snoop filter correlates to the size of the cache, so increasing the cache requires increasing the snoop filter.

A solution is needed that scales well for large caches minimizing a degrade in performance or an increase in hardware cost.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates a computing system in accordance with various embodiments.

FIG. 2 illustrates another computing system in accordance with various embodiments.

FIG. 3 illustrates another computing system in accordance with various embodiments.

FIG. 4 illustrates a graphics (GFX) snoop filter hash array in accordance with various embodiments.

FIG. 5 illustrates a snoop filter configuration in accordance with various embodiments.

FIG. 6 illustrates a refresh handshake in accordance with various embodiments.

FIG. 7 illustrates another snoop filter configuration in accordance with various embodiments.

FIG. 8 illustrates another refresh handshake in accordance with various embodiments.

### DETAILED DESCRIPTION

Embodiments described herein may include apparatus, systems, techniques, and/or processes that are directed to computing systems implementing a very large cache for one or more processing engines in a shared memory system. According to various embodiments, a snoop filter tracks a hash value of the cached addresses instead of tracking the addresses themselves. Tracking hash values introduces inaccuracy and an inability to easily clean or refresh the snoop filter. A refresh algorithm maintains cache coherency without significant performance degradation. The cache refresh algorithm keeps the accuracy of the snoop filter, hence reducing the latency and power effects of false snoops. Further, the use of hash values reduces the hardware cost over traditional snoop filters.

In the following description, various aspects of the illustrative implementations will be described using terms commonly employed by those skilled in the art to convey the substance of their work to others skilled in the art. However, it will be apparent to those skilled in the art that embodiments of the present disclosure may be practiced with only some of the described aspects. For purposes of explanation, specific numbers, materials, and configurations are set forth in order to provide a thorough understanding of the illustrative implementations. It will be apparent to one skilled in the art that embodiments of the present disclosure may be practiced without the specific details. In other instances, well-known features are omitted or simplified in order not to obscure the illustrative implementations.

In the following detailed description, reference is made to the accompanying drawings that form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

As used herein, the term “module” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable components that provide the described functionality.

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

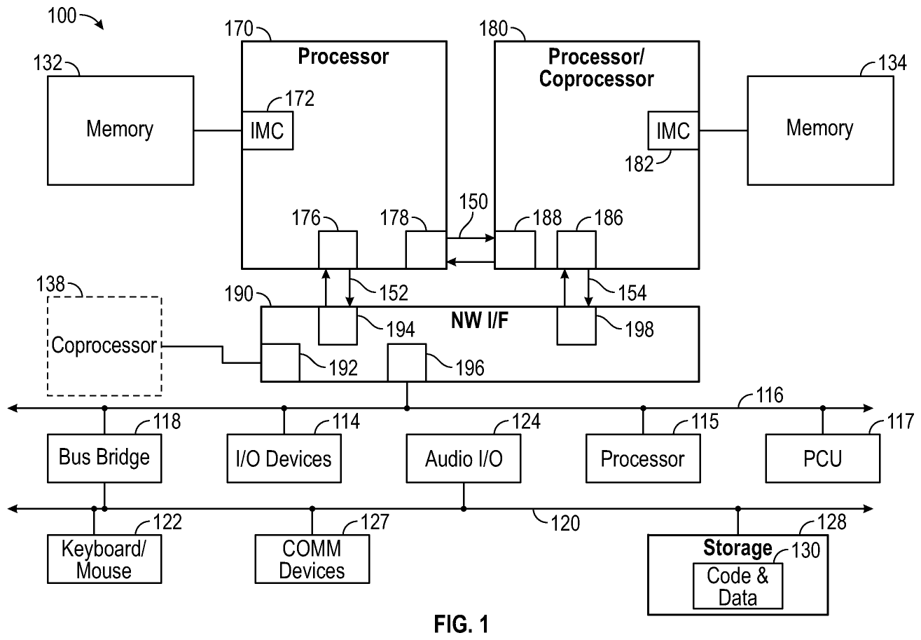

FIG. 1 illustrates a computing system in accordance with various embodiments. Multiprocessor system 100 is an interfaced system and includes a plurality of processors or cores including a first processor 170 and a second processor 180 coupled via an interface 150 such as a point-to-point (P-P) interconnect, a fabric, and/or bus. In some examples, the first processor 170 and the second processor 180 are homogeneous. In some examples, first processor 170 and the second processor 180 are heterogenous. Though the example system 100 is shown to have two processors, the system may have three or more processors, or may be a single processor system. In some examples, the computing system is a system on a chip (SoC).

Processors 170 and 180 are shown including integrated memory controller (IMC) circuitry 172 and 182, respectively. Processor 170 also includes interface circuits 176 and 178; similarly, second processor 180 includes interface circuits 186 and 188. Processors 170, 180 may exchange information via the interface 150 using interface circuits 178, 188. IMCs 172 and 182 couple the processors 170, 180 to respective memories, namely a memory 132 and a memory 134, which may be portions of main memory locally attached to the respective processors.

Processors 170, 180 may each exchange information with a network interface (NW I/F) 190 via individual interfaces 152, 154 using interface circuits 176, 194, 186, 198. The network interface 190 (e.g., one or more of an interconnect, bus, and/or fabric, and in some examples is a chipset) may optionally exchange information with a coprocessor 138 via an interface circuit 192. In some examples, the coprocessor 138 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 170, 180 or outside of both processors, yet connected with the processors via an interface such as P-P interconnect, such that either or both processors' local cache information may be stored in the shared cache if a processor is placed into a low power mode.

Network interface 190 may be coupled to a first interface 116 via interface circuit 196. In some examples, first interface 116 may be an interface such as a Peripheral Component Interconnect (PCI) interconnect, a PCI Express interconnect or another I/O interconnect. In some examples, first interface 116 is coupled to a power control unit (PCU) 117, which may include circuitry, software, and/or firmware to perform power management operations with regard to the processors 170, 180 and/or co-processor 138. PCU 117 provides control information to a voltage regulator (not shown) to cause the voltage regulator to generate the appropriate regulated voltage. PCU 117 also provides control information to control the operating voltage generated. In various examples, PCU 117 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 117 is illustrated as being present as logic separate from the processor 170 and/or processor 180. In other cases, PCU 117 may execute on a given one or more of cores (not shown) of processor 170 or 180. In some cases, PCU 117 may be implemented as a microcontroller (dedicated or general-purpose) or other control logic configured to execute its own dedicated power management code, sometimes referred to as P-code. In yet other examples, power management operations to be performed by PCU 117 may be implemented externally to a processor, such as by way of a separate power management integrated circuit (PMIC) or another component external to the processor. In yet other examples, power management operations to be performed by PCU 117 may be implemented within BIOS or other system software.

Various I/O devices 114 may be coupled to first interface 116, along with a bus bridge 118 which couples first interface 116 to a second interface 120. In some examples, one or more additional processor(s) 115, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 116. In some examples, second interface 120 may be a low pin count (LPC) interface. Various devices may be coupled to second interface 120 including, for example, a keyboard and/or mouse 122, communication devices 127 and storage circuitry 128. Storage circuitry 128 may be one or more non-transitory machine-readable storage media as described below, such as a disk drive or other mass storage device which may include instructions/code and data 130. Further, an audio I/O 124 may be coupled to second interface 120. Note that other architectures than the point-to-point architecture described above are possible. For example, instead of the point-to-point architecture, a system such as multiprocessor system 100 may implement a multi-drop interface or other such architecture.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

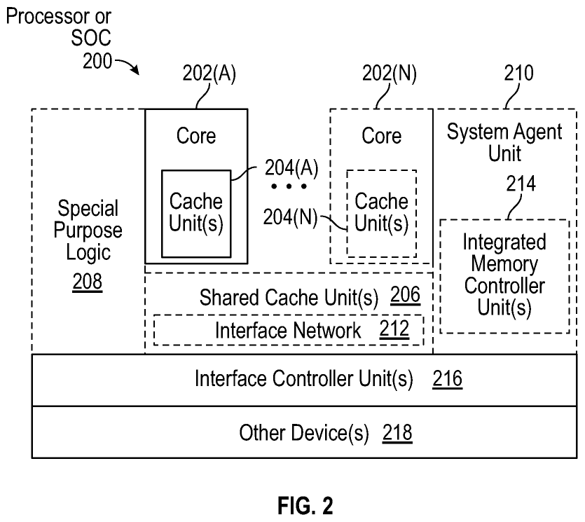

FIG. 2 illustrates another computing system in accordance with various embodiments. An SoC 200 that may have one or more cores and an integrated memory controller. The solid lined boxes illustrate an SoC 200 with a single core 202(A), system agent unit circuitry 210, and a set of one or more interface controller unit(s) circuitry 216, while the optional addition of the dashed lined boxes illustrates an alternative processor 200 with multiple cores 202(A)-(N), a set of one or more integrated memory controller unit(s) circuitry 214 in the system agent unit circuitry 210, and special purpose logic 208, as well as a set of one or more interface controller units circuitry 216. Note that the processor 200 may be one of the processors 170 or 180, or co-processor 138 or 115 of FIG. 1.

Thus, different implementations of the processor 200 may include: 1) a CPU with the special purpose logic 208 being integrated graphics and/or scientific (throughput) logic (which may include one or more cores, not shown), and the cores 202(A)-(N) being one or more general purpose cores (e.g., general purpose in-order cores, general purpose out-of-order cores, or a combination of the two); 2) a coprocessor with the cores 202(A)-(N) being a large number of special purpose cores intended primarily for graphics and/or scientific (throughput); and 3) a coprocessor with the cores 202(A)-(N) being a large number of general purpose in-order cores. Thus, the processor 200 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 200 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 204(A)-(N) within the cores 202(A)-(N), a set of one or more shared cache unit(s) circuitry 206, and external memory (not shown) coupled to the set of integrated memory controller unit(s) circuitry 214. The set of one or more shared cache unit(s) circuitry 206 may include one or more mid-level caches, such as level 2 (L2), level 3 (L3), level 4 (L4), or other levels of cache, such as a last level cache (LLC), and/or combinations thereof. While in some examples interface network circuitry 212 (e.g., a ring interconnect) interfaces the special purpose logic 208 (e.g., integrated graphics logic), the set of shared cache unit(s) circuitry 206, and the system agent unit circuitry 210, alternative examples use any number of well-known techniques for interfacing such units. In some examples, coherency is maintained between one or more of the shared cache unit(s) circuitry 206 and cores 202(A)-(N). In some examples, interface controller units circuitry 216 couple the cores 202 to one or more other devices 218 such as one or more I/O devices, storage, one or more communication devices (e.g., wireless networking, wired networking, etc.), etc.

In some examples, one or more of the cores 202(A)-(N) are capable of multi-threading. The system agent unit circuitry 210 includes those components coordinating and operating cores 202(A)-(N). The system agent unit circuitry 210 may include, for example, power control unit (PCU) circuitry and/or display unit circuitry (not shown). The PCU may be or may include logic and components needed for regulating the power state of the cores 202(A)-(N) and/or the special purpose logic 208 (e.g., integrated graphics logic). The display unit circuitry is for driving one or more externally connected displays.

The cores 202(A)-(N) may be homogenous in terms of instruction set architecture (ISA). Alternatively, the cores 202(A)-(N) may be heterogeneous in terms of ISA; that is, a subset of the cores 202(A)-(N) may be capable of executing an ISA, while other cores may be capable of executing only a subset of that ISA or another ISA.

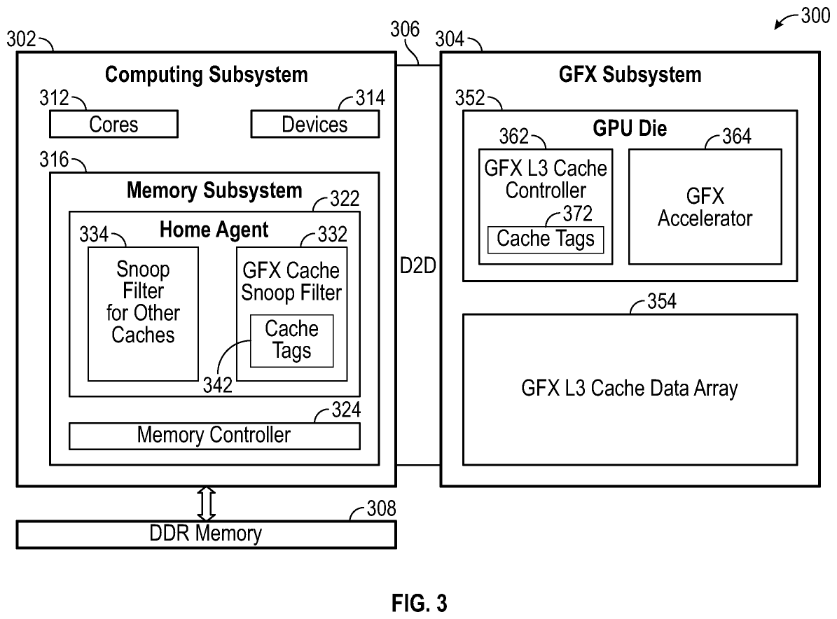

FIG. 3 illustrates another computing system in accordance with various embodiments. Computing system 300 has a computing subsystem 302 and a graphics (GFX) subsystem 304 coupled by a device to device (D2D) link 306, however, any communication link may be utilized. As illustrated, computing subsystem 302 and GFX subsystem 304 are communicably coupled to a double data rate (DDR) memory 308.

Computing subsystem 302 includes one or more processing cores 312, one or more input/output (IO) devices 314, and a memory subsystem 316. Memory subsystem 316 includes a home agent 322 and a memory controller 324. Home agent 322 maintains coherency between all caching agents. Home agent 322 includes a GFX snoop filter 332 and one or more snoop filters for other caches 334. GFX snoop filter 332 includes cache tag array 342 corresponding to the addresses of the data stored in GFX caches. GFX snoop filter 332 has an encoded or hash value generator to encode the addresses of the data stored in GFX caches. GFX snoop filter 332 also creates an encoded or hash value of physical addresses when it observes a memory transaction and looks up the value in cache tag array 342 to determine if a state bit is set.

According to some embodiments, GFX subsystem 304 includes GPU die 352 and GFX level 3 (L3) cache data array 354. GPU die 352 includes a GFX L3 Cache controller 362 and GFX accelerator 364. Note that cache data array 354 may also be implemented on the same die as GFX accelerator 364. GPU die 352 may have any number of levels of caches. GPU die 362 may have multiple GFX accelerators 364 and multiple IO devices (not shown). GFX L3 cache data array 354 may include a data array on another die using a 2D or 3D multi-die technology. GFX L3 cache controller 362 includes a cache tag array 372, which may also be on another die.

GFX cache 354 is maintained coherent with all other cores and devices in computing system 300. Coherency is achieved using snoop filter 332 in home agent 322. When GFX accelerator 364 assumes ownership of a data piece, it is registered in snoop filter 332. When any other agent issues a memory read or write request, home agent 322 does a lookup in snoop filter 332. If snoop filter 332 indicates that the data is owned by GFX cache 354, a snoop is sent to GFX cache 354 to read the most up to date data and/or to flush the data from GFX cache 354.

While a configuration of computing system 300 has been described, alternative embodiments may have different configurations. While computing system 300 is described as including the components illustrated in FIG. 3, alternative embodiments may include additional components that facilitate the operation of computing system 300. For example, GFX subsystem 304 may be any type of accelerator or processing engine having one or more levels of large cache and associated snoop filter. The components of computing system 300 may be in multiple different packages, the same package, with different interconnects, fewer or more cores 312 and IO devices 314, alternate types of memory 308 and the like.

In typical implementations, a cache tag array in a GFX subsystem is approximately the same size as a snoop filter cache tag array in a home agent. According to various embodiments, it is desirable to provide a GFX accelerator with one or more very large caches, making the cache tag array in the GFX accelerator also very large. According to various embodiments, the size of the snoop filter cache tag array in the home agent may be reduced by only recording a signature of the addresses, for example by the use of encoding or hashing the corresponding addresses in the cache tag array in the snoop filter. A snoop filter hash function may compress multiple bits of a physical address, for example, the upper bits of the address, storing fewer bits in the cache tag array of the snoop filter.

As an example, if GFX cache 354 is 1 gigabyte (GB) with a physical address size of 44 bit, its cache would have 16 slices, each having 16 ways and 8K set, and cache entries of 512 bytes (a group of 8 64B cache lines). Thus, the tag array of the GFX cache has 18 bits of tag in each entry and an overall tag array size of 4.5 MB. If the snoop filter hash function compresses the 19 upper bits of the physical address into 7 bits, the snoop filter having 8K sets with each set having a bit for each of the 128 combinations of the hash function, the snoop filter size would be only 128 KB or 1/36 the size of the GFX tag array size. Realizing these savings, a snoop filter using hash value may support extremely large caches with low hardware costs. Caches of other sizes and corresponding cache tags may be realized and benefit from the disclosed techniques. Also note that the implementation of the snoop filter in the home agent is independent of the division of the GFX cache in 16 slices. Different numbers of sets and cache line sizes may be implemented.

According to various embodiments, GFX cache 354 and its tag array 372 may be increased while keeping snoop filter 332 and its cache tag array 342 relatively small. This is achieved by snoop filter 332 tracking cache accesses in high granularity using a hashing or filtering technique. For example, instead of maintaining GFX cached addresses, a signature of the addresses may be kept, for example, using a hash function or filtering function.

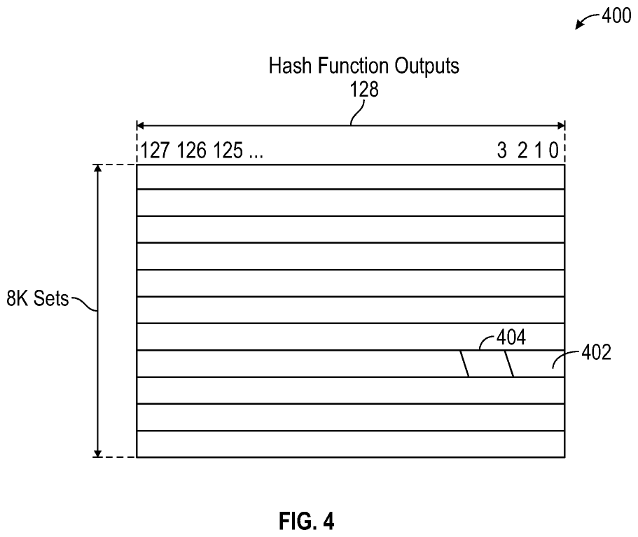

FIG. 4 illustrates a GFX snoop filter hash array 400 in accordance with various embodiments. When a GFX cache sends an ownership request for data with a physical address, a hash function may be calculated over the physical address hashed range, generating, for example, a seven bit hash. The hash function may be encoded, generating, for example, a 128 bit encoded hash 402. Each address is mapped to a bit in the GFX snoop filter as illustrated by encoded hash state bit 404 in encoded hash 402. Note that encoded hash state bit 404 may also be referred to as a set bit or a valid bit. Encoded hash state bit 404 is set to ′1 when the GFX requests address ownership. Encoded hash state bit 404 is checked when another agent sends an access to the address. If the bit is ′1, the GFX cache is snooped.

When another agent issues a read/write request to memory through the home agent, the hash function may be calculated over the physical address hashed range, generating a seven bit hash. The hash function is encoded, generating a 128 bit hash.

If encoded hash state bit 404 is set, it means that the requested address may be cached in the GFX cache. A snoop request is sent to the GFX cache to acquire the most up to date data and/or to invalidate the data from the GFX cache. If encoded hash state bit 404 is clear, it means that the requested address must not be cached in the GFX cache. The home agent may proceed with access the main memory without snooping the GFX cache.

The example shown in FIG. 4 includes suggested configurations. Caches, cache tag arrays, and hash tags of other sizes and corresponding cache tags may be realized and benefit from the disclosed techniques.

According to various embodiments, any type of hashing or encoding function may be used to reduce the tracked physical addresses to a smaller size. For example, a hash function may exclusive-or (XOR) a group of bits in the hash range. A hash function may generate a Hash[0] by XORing each bit of the hash range, Hash[1] by XORing every other bit of the hash range, Hash[2] by XORing every third bit in the hash range and so forth, with Hash[6] generated by XORing every seventh bit in the hash range. In accordance with some embodiments, the function may include XORing some of the state bits, to create a different hash function for each set.

According to various embodiments, any other types of encoding functions with unique distribution of the physical address space may be implemented. For example, taking any seven bits of the hashed range may be used if the memory is uniformly accessed.

These type of hashing or encoding functions may be referred to as bloom filters. A bloom filter is a data structure that is used to test whether an element is a member of a set. False positive matches are possible, but false negatives are not—in other words, a query returns either “possibly in set” or “definitely not in set.” False positives increase the inaccuracy of the snoop filter. Further, the larger the number of elements in the set, the larger the inaccuracy of the snoop filter.

Thus, false snoops may occur due aliasing. That is, several items of the original set may be mapped to the same value of the compressed set. As such, several addresses may be represented in the snoop filter using a single bit. A snoop filter may not be able to distinguish between access to the same address that was cached by the GFX cache (for which a snoop is needed) and an access to another address that was never cached by the GFX cache (for which a snoop is not needed). As a result, in many cases a redundant snoop is generated. Reducing this effect may be accomplished by increasing the snoop filter size up to a level in which the probability of false snoops is reduced to an acceptable penalty.

Another issue with bloom filters includes an inability to quickly clean the snoop filter. In a legacy snoop filter, the accuracy of the snoop filter may be achieved by tracking the cases where a cache line is being evicted from the tracked cache. This may be performed by tracking of ‘dirty eviction’ (where the evicted data is modified and hence written as a writeback to memory) and ‘clean eviction’ (the evicted data is not modified and could be silently evicted from the cache, but the cache may choose to send a notification to the snoop filter to keep its accuracy). With a bloom filter, the operation of eviction from the cache cannot be used to clean the snoop filter, because it's possible that another address that has the same hash function is valid in the GFX cache. Cleaning the snoop filter on eviction will lose the knowledge about the other cache line, leading to a coherency mismatch. According to various embodiments, the accuracy of the snoop filter may be improved while reducing false snoops by using one of the snoop filter refresh flows described below.

In accordance with various embodiments, the contents of the snoop filter are refreshed and renewed on a regular basis. The basic flow of the snoop filter refresh includes first blocking current activity of the system (or at least blocking accesses from the GFX cache to the memory and blocking accesses from other agents that may snoop the GFX cache. Next, the snoop filter contents are cleared, for example, by setting all bits to zero. Next, the GFX cache manager applies a scanner that goes over all addresses that are currently cached, and re-requests ownership of those addresses. When the ownership requests are approved, the snoop filter sets the appropriate state bits to ′1. When the refresh process is done, all state bits set to ′1 in the snoop filter represent data that remains valid in the GFX cache, and no longer old data that was already evicted from the cache. This flow, while effective, interrupts the system for long periods during the refresh process, causing significant performance impact.

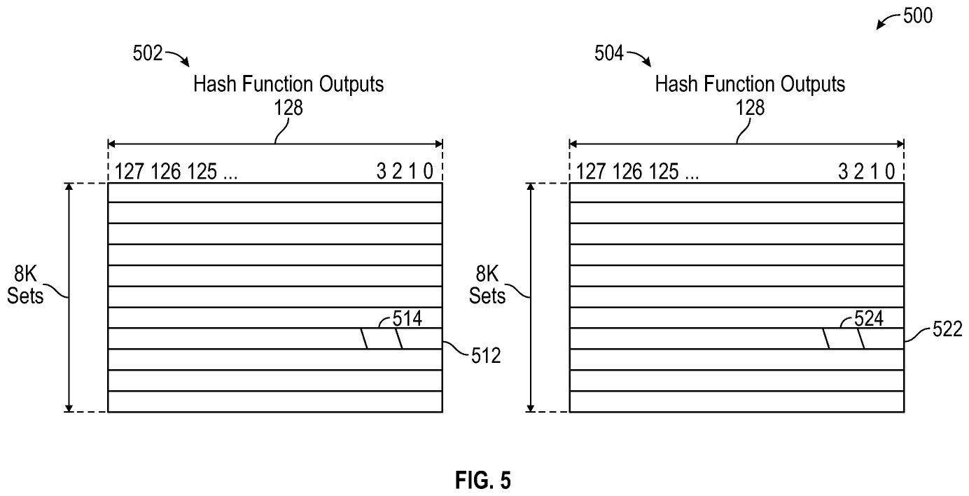

FIG. 5 illustrates a snoop filter configuration in accordance with various embodiments. Snoop filter 500 includes a first instance 502 of a snoop filter hash array and a second instance 504 of a snoop filter hash array. By implementing two instances, one hash array may be an active instance while the other is a shadow instance. The active/shadow role of each instance is not constant but is switched with every refresh. During normal mode (when not doing refresh) only the active array is used, while the shadow array is zeroed and is not accessed. This implementation enables the refresh process to proceed without blocking any activity.

Referring to FIG. 5, first instance 502 may be currently the active instance, while instance 504 may be the shadow instance. This designation is switched with every snoop filter refresh. Each address is mapped to 1 state bit in each of instances 502 and 504 of the snoop filter, for example hash state bit 514 of encoded hash 512 and hash state bit 524 of encoded hash 522. Hash state bit 514 in active instance 502 is set to ′1 when ownership is requested. Both hash state bits 514 and 524 are checked when another agent accesses the address. If either of the hash state bits 514 and 524 is set to ′1, the GFX cache is snooped.

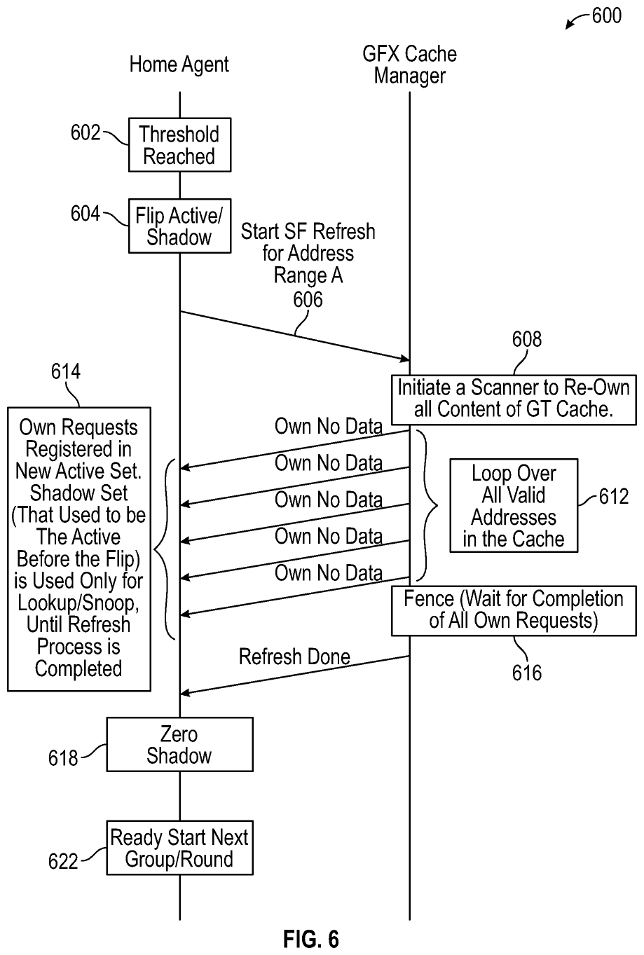

FIG. 6 illustrates a refresh handshake in accordance with various embodiments. Flow 600 illustrates a flow for a snoop filter configured similarly to that illustrated in FIG. 5. According to various embodiments, the refresh of the snoop filter cache array begins, for example when a set threshold is reached, block 602. The snoop filter switches the arrays from active to shadow and shadow to active, block 604. In addition, the active instance is cleared and the shadow instance retains all the addresses that were previously cached. The GFX engine is notified to start the cache scanner and re-own all addresses, flow 606. The GFX engine initiates a scanner to re-own all content of the GFX tag cache, block 608, looping over all valid addresses in the cache, block 612. All re-own requests, as well as new requests due to normal ongoing traffic, are registered in the active instance of the array, block 614.

The flow waits for the completion of all own requests, block 616. During this waiting time, when a request comes from another agent during the refresh process, the snoop filter checks the appropriate state bit in both the active and shadow arrays. If any of these state bits is ′1, a snoop is required. The snoop filter is unaware of the progress of the refresh flow in the GFX cache, so state bits that are still set in the shadow array are suspected to be still valid in the GFX cache. When the process ends (after all re-own requests from GFX cache are completed), the shadow array is zeroed in preparation for the next refresh process, block 618. The snoop filter is now ready to trigger another refresh flow, as required, block 622. While effective, this approach may double the required area for the snoop filter. In the example above, the required area is doubled from 128 KB to 256 KB.

According to various embodiments, the clearing of the active array at the beginning of the refresh flow may not be performed if the array was already cleared at the end of a previous refresh flow when it was a shadow array in that previous flow.

As illustrated, a home agent performs or initiates the processes and functions of blocks 602, 604, 614, 618, 622 and flow 606 while a GFX cache manager performs or initiates the processes and functions of blocks 608, 612 and 616 where both the home agent and the GFX cache manager are represented as single entities. According to various embodiments, the single entities may be multiple entities. Further, different entities may perform some or all of the processes and functions, not shown.

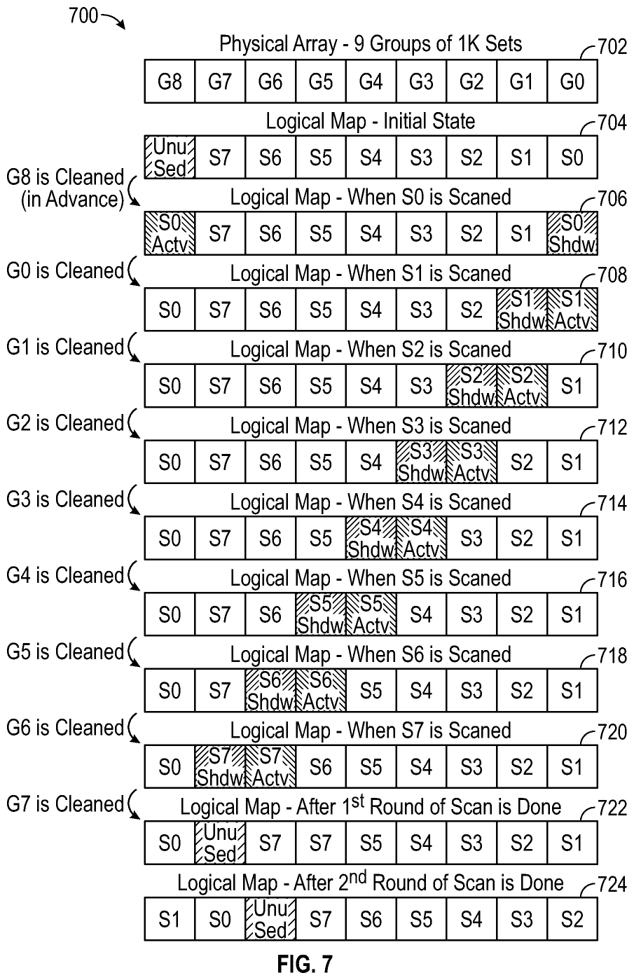

FIG. 7 illustrates another snoop filter configuration 700 in accordance with various embodiments. A refresh may be performed in smaller portions, resulting in a smaller shadow array. For a refresh of (1/N) of the array each time, the area increases to ((N+1)/N) of the original array. As illustrated, the refresh process is performed over groups of 1K sets at a time. Physical array 702 include 8 groups of 1K sets, G0-G7 plus an additional group G8 resulting in overall 9K sets. In the initial state, logical map 704 consists of sets S0-S7 each of which is mapped one of physical group G0-G7, with an eighth set unused and cleared. Normally, a single physical group is assigned for each logical group.

During the refresh process, the extra physical group is given to the logical group that is being refreshed and is used as the shadow array for this logical group. For example, when the refresh process starts, the unused physical group is assigned to logical group S0 to serve as the new active array of this group, while the old physical group of logical group S0 serves as the shadow array as illustrated in logical map 706. When the refresh of group 0 is finished, the shadow is cleared, and then it is assigned to serve as the new active array for the next group to be refreshed. The extra physical group may move between the logical groups in a rolling manner as shown in logical maps 708 thru 724. As illustrated, the refresh continues rotating the active and shadow groups until the entire physical array is refreshed. Similar to the examples shown in FIGS. 5 and 6, each address is mapped to one logical state bit in the GFX snoop filter. The logical state bit is mapped to a state bit in the active group of its set. When the set is being refreshed, the logical state bit is also mapped to a state bit in the shadow group of its set. The state bit in the active group is set to ′1 when FGX requests address ownership. The state bit in the active group and the state bit in the shadow group (when this set is being refreshed) are checked when another agent accesses this address. If either of the state bits are ′1, the GFX cache is snooped.

According to various embodiments, refreshes may be performed on larger or smaller sized groups and in any particular order as needed.

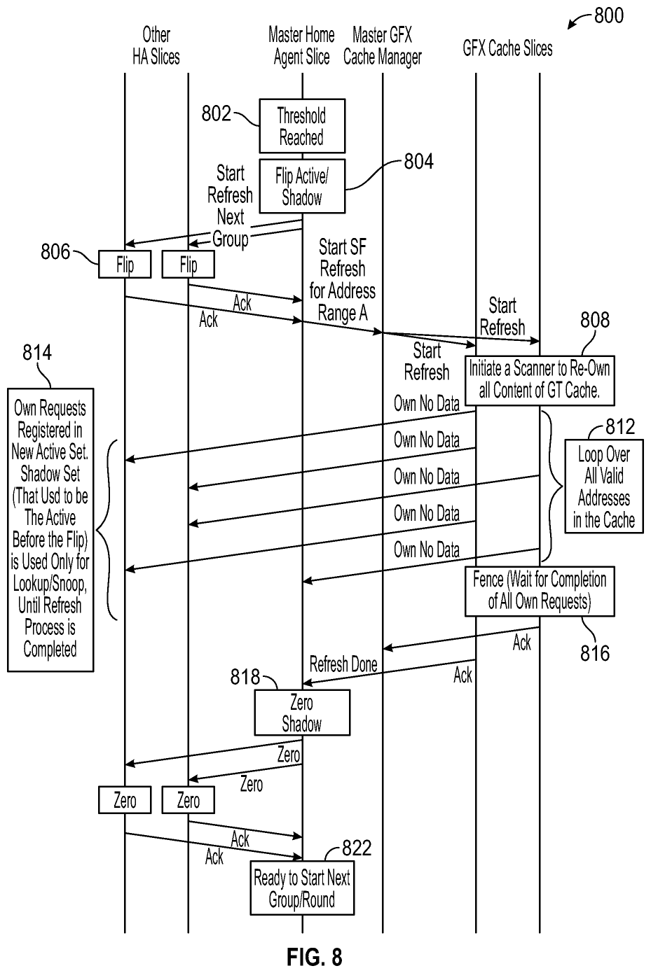

FIG. 8 illustrates another refresh handshake in accordance with various embodiments. Flow 800 illustrates a flow for a snoop filter configured similarly to that illustrated in FIG. 7, with the snoop filter cache tag array split into multiple slices. The steps are similar to those of flow 600 of FIG. 6, with a few differences. When both home agent and GFX cache are implemented as a set of slices (where the mapping to slices is different in each entity, that is, a slice of the GFX cache may be mapped to more than one slice of the home agent, and vice versa or alternatively, have a completely independent mapping such as a slice of the GFX cache mapped to portions of a few slices in the home agent and vice versa).

According to various embodiments, the home agent may have a master slice or central logic that needs to be refreshed (note that other slices may also need to be refreshed, flow 800 shows the refresh of one slice), the refresh of the snoop filter cache slice begins, block 802. The snoop filter switches the slices from active to shadow and shadow to active, block 804. The active instance is cleared and the shadow instance retains all the addresses that were previously cached. All other slices also make the same preparation, and the home agent waits until all slices have sent acknowledgements (Ack). The home agent communicates with the master GFX cache slice (or a manager of all slices). The cache master informs all the slices to do the re-own process, and waits until acknowledged by all slices before informing the master home agent that it's done, block 806. The GFX engine initiates a scanner to re-own all content of the GFX tag cache slice, block 808, looping over all valid addresses in the slice, block 812. All re-own requests, as well as new requests due to normal ongoing traffic, are registered in the active instance of the slice, block 814.

The flow waits for the completion of all own requests, block 816. During this waiting time, when a request comes from another agent during the refresh process, the snoop filter checks the appropriate state bit in both the active and shadow slices. If any of these state bits is ′1, a snoop is required. The snoop filter is unaware of the progress of the refresh flow in the GFX cache, so state bits that are still set in the shadow slice are suspected to be still valid in the GFX cache. When the process ends (after all re-own requests from GFX cache are completed), the master home agent informs all other slices that it's time to zero the shadow slice (and move to next group of sets if needed), and waits until acknowledged by all slices, block 818. The snoop filter is now ready to trigger another refresh flow, as required, block 822.

According to various embodiments, the clearing of the active slice(s) at the beginning of the refresh flow may not be performed if the slice(s) was already cleared at the end of a previous refresh flow when it was a shadow slice in that previous flow.

As illustrated, a master home agent and/or other home agents perform or initiate the processes and functions of blocks 802, 804, 806, 814, 818, and 822 while a GFX cache manager performs or initiates the processes and functions of blocks 808, 812 and 816 where both the home agents and the GFX cache manager are represented as single entities. According to various embodiments, the single entities may be multiple entities. Further, different entities may perform some or all of the processes and functions, not shown.

According to some embodiments, a part of the refresh protocol as illustrated in FIGS. 7 and 8, the home agents and the GFX cache management entities coordinate and or agree on the address range that is being refreshed. With the use of common ‘mask and match’ address registers, the address arrangement of the entities may be disaggregated. For example, four bits may be used by the snoop filter to select 1 of 8 logical groups. The home agent(s) sends the 3-bits of the logical group ID with the refresh command. The GFX cache does the refresh only for sets with that ID on the selected four bits. Other mask bit sizes may also be used, for example, to identify different, larger, or smaller sets of data.

According to various embodiments, the refresh flow may be triggered in a variety of ways. An implementation may choose a scheme according to statistics, performance studies and implementation restrictions. For example, the trigger may be time based such that the refresh is triggered every X time units. The trigger may be snoop filter occupancy based where when an overall number of ′1 state bits in the snoop filter is above a set threshold or percentage of state bits, or when more than N sets have more than a set number or percentage of ′1 state bits. The trigger may be snoop based, for example when a percentage of snoop filter lookups that result in a snoop is above a set threshold.

Although embodiments described herein refer to a GFX processing engine or accelerator and corresponding GFX snoop filter, techniques described herein are equally applicable to any type of processing engine with a large cache and the need to minimize the size of its corresponding snoop filter.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The above description of illustrated embodiments, including what is described in the Abstract, is not intended to be exhaustive or to limit embodiments to the precise forms disclosed. While specific embodiments are described herein for illustrative purposes, various equivalent modifications are possible within the scope of the embodiments, as those skilled in the relevant art will recognize.

These modifications may be made to the embodiments in light of the above detailed description. The terms used in the following claims should not be construed to limit the embodiments to the specific implementations disclosed in the specification and the claims. Rather, the scope of the invention is to be determined entirely by the following claims, which are to be construed in accordance with established doctrines of claim interpretation.

### Examples

The following examples pertain to further embodiments. An example may be a method, comprising detecting a memory access with a physical address to a shared memory; creating a hash value of a subset of the physical address; identifying a state bit corresponding to the hash value in a snoop filter cache tag array; and snooping a cache with the physical address if the state bit is set.

Another example includes wherein the state bit indicates there is a chance the physical address is owned by the cache if set and indicates the physical address is not owned by the cache if not set.

Another example includes refreshing a first portion of the snoop filter cache tag array, the refreshing comprising: initiating requests for ownership of a set of physical addresses of data stored in the cache; creating a new hash value for an approved address of the set of physical addresses, recording the new hash value in a second portion of the snoop filter cache tag array and setting a corresponding new state bit in the second portion of the snoop filter cache tag array; and repeating the creating, the recording, and the setting for each approved address of the set of physical addresses; and clearing the first portion of the snoop filter cache tag array after all of the requests for ownership have been processed.

Another example includes wherein the refreshing further includes: detecting another memory access with another physical address to the shared memory; creating another hash value of a subset of the another physical address; identifying a first state bit corresponding to the another hash value in the first portion of the snoop filter cache tag array, and identifying a second state bit corresponding to the another hash value in the second portion of the snoop filter cache tag array; and snooping the cache with the another physical address if at least one of the first state bit and the second state bit is set.

Another example includes wherein the first and the second state bits indicate there is a chance the another physical address is owned by the cache if either is set and indicating the another physical address is not owned by the cache if both the first and the second state bits are not set.

Another example includes wherein the snooping the cache with the another physical address results in a redundant snoop.

Another example includes wherein the refreshing is initiated when a number of snoops exceeds a set threshold.

Another example includes wherein the another hash value represents more than one physical address.

Another example includes an apparatus including a snoop filter to maintain coherency of a cache, the snoop filter comprising: an encoded value generator to create an encoded value from a subset of a physical address of data stored in the cache, the encoded value generator to create another encoded value from another subset of another physical address of a memory transaction; a snoop filter cache tag array to store the encoded value and set a corresponding state bit; the snoop filter to identify the another encoded value in the snoop filter cache tag array and another corresponding state bit; the snoop filter to initiate a snoop of the cache if the another corresponding state bit is set.

Another example includes wherein the state bit indicates there is a chance the physical address is owned by the cache if set and indicates the physical address is not owned by the cache if not set.

Another example includes wherein the snoop filter further to initiate a refresh of a first portion of the snoop filter cache tag array and store refreshed data in a second portion of the snoop filter cache tag array, wherein if a new memory transaction is observed during the refresh, the snoop filter to check both the first portion and the second portion of the snoop filter cache tag array for the new encoded value of the new physical address to determine if the cache owns the new physical address.

Another example includes the snoop filter to further clear the first portion of the snoop filter cache tag array when the refresh is complete.

Another example includes wherein the snoop filter to initiate the refresh when a number of snoops exceeds a set threshold.

Another example includes wherein the encoded value represents more than one physical address.

Another example includes a system including a cache and a cache tag array; and a snoop filter to maintain coherency of the cache, the snoop filter comprising: an encoded value generator to create an encoded value from a subset of a physical address of data stored in the cache, the encoded value generator to create another encoded value from another subset of another physical address of a memory transaction; a snoop filter tag array to store the encoded value and set a corresponding state bit; the snoop filter to identify the another encoded value in the snoop filter tag array and another corresponding state bit; the snoop filter to initiate a snoop of the cache if the another corresponding state bit is set; wherein the snoop tag array is 1/Nth a size of the cache tag array, and N is at least 2.

Another example includes wherein the state bit indicates there is a chance the physical address is owned by the cache if set and indicates the physical address is not owned by the cache if not set.

Another example includes wherein the snoop filter further to initiate a refresh of a first portion of the snoop filter tag array and store refreshed data in a second portion of the snoop filter tag array, wherein if a new memory transaction is observed during the refresh, the snoop filter to check both the first portion and the second portion of the snoop filter tag array for the new encoded value of the new physical address to determine if the cache does not own the new physical address.

Another example includes the snoop filter to further clear the first portion of the snoop filter tag array when the refresh is complete.

Another example includes wherein the snoop filter to initiate the refresh when a number of set state bits exceeds a set threshold.

Another example includes wherein the encoded value represents more than one physical address.

Another example may include an apparatus comprising means to perform one or more elements of a method described in or related to any of examples herein, or any other method or process described herein.

Another example may include one or more non-transitory computer-readable media comprising instructions to cause an electronic device, upon execution of the instructions by one or more processors of the electronic device, to perform one or more elements of a method described in or related to any of examples herein, or any other method or process described herein.

Another example may include an apparatus comprising logic, modules, or circuitry to perform one or more elements of a method described in or related to any of examples herein, or any other method or process described herein.

Another example may include a method, technique, or process as described in or related to any of examples herein, or portions or parts thereof.

Another example may include an apparatus comprising: one or more processors and one or more computer readable media comprising instructions that, when executed by the one or more processors, cause the one or more processors to perform the method, techniques, or process as described in or related to any of examples herein, or portions thereof.

Another example may include a signal as described in or related to any of examples herein, or portions or parts thereof.

Understand that various combinations of the above examples are possible.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SoC or other processor, is to configure the SoC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. At least one machine readable medium comprising a plurality of instructions which, when executed on a computing device, cause the computing device to:
detect a memory access with a physical address to a shared memory;
create a hash value of a subset of the physical address;
identify a state bit corresponding to the hash value in a snoop filter cache tag array; and
snoop a cache with the physical address if the state bit is set.

2. The machine-readable medium of claim 1, wherein the state bit indicates there is a chance the physical address is owned by the cache if set and indicates the physical address is not owned by the cache if not set.

3. The machine-readable medium of claim 1, the plurality of instructions further cause the computing device to refresh a first portion of the snoop filter cache tag array, the refresh comprising:
initiating requests for ownership of a set of physical addresses of data stored in the cache;
creating a new hash value for an approved address of the set of physical addresses, recording the new hash value in a second portion of the snoop filter cache tag array and setting a corresponding new state bit in the second portion of the snoop filter cache tag array; and
repeating the creating, the recording, and the setting for each approved address of the set of physical addresses; and
clearing the first portion of the snoop filter cache tag array after all of the requests for ownership have been processed.

4. The machine-readable medium of claim 3, wherein the refresh further comprises:
detecting another memory access with another physical address to the shared memory;
creating another hash value of a subset of the another physical address;
identifying a first state bit corresponding to the another hash value in the first portion of the snoop filter cache tag array, and identifying a second state bit corresponding to the another hash value in the second portion of the snoop filter cache tag array; and
snooping the cache with the another physical address if at least one of the first state bit and the second state bit is set.

5. The machine-readable medium of claim 4, wherein the first and the second state bits indicate there is a chance the another physical address is owned by the cache if either is set and indicating the another physical address is not owned by the cache if both the first and the second state bits are not set.

6. The machine-readable medium of claim 4, wherein the snooping the cache with the another physical address results in a redundant snoop.

7. The machine-readable medium of claim 4, wherein the refresh is initiated when a number of snoops exceeds a set threshold.

8. The machine-readable medium of claim 4, wherein the another hash value represents more than one physical address.

9. An apparatus comprising:
a snoop filter to maintain coherency of a cache, the snoop filter comprising:
an encoded value generator to create an encoded value from a subset of a physical address of data stored in the cache, the encoded value generator to create another encoded value from another subset of another physical address of a memory transaction;
a snoop filter cache tag array to store the encoded value and set a corresponding state bit;
the snoop filter to identify the another encoded value in the snoop filter cache tag array and another corresponding state bit; the snoop filter to initiate a snoop of the cache if the another corresponding state bit is set.

10. The apparatus of claim 9, wherein the state bit indicates there is a chance the physical address is owned by the cache if set and indicates the physical address is not owned by the cache if not set.

11. The apparatus of claim 9, wherein the snoop filter further to initiate a refresh of a first portion of the snoop filter cache tag array and store refreshed data in a second portion of the snoop filter cache tag array, wherein if a new memory transaction is observed during the refresh, the snoop filter to check both the first portion and the second portion of the snoop filter cache tag array for the new encoded value of the new physical address to determine if the cache owns the new physical address.

12. The apparatus of claim 11, the snoop filter to further clear the first portion of the snoop filter cache tag array when the refresh is complete.

13. The apparatus of claim 11, wherein the snoop filter to initiate the refresh when a number of snoops exceeds a set threshold.

14. The apparatus of claim 11, wherein the encoded value represents more than one physical address.

15. A system apparatus comprising:
a cache and a cache tag array; and
a snoop filter to maintain coherency of the cache, the snoop filter comprising:
an encoded value generator to create an encoded value from a subset of a physical address of data stored in the cache, the encoded value generator to create another encoded value from another subset of another physical address of a memory transaction;
a snoop filter tag array to store the encoded value and set a corresponding state bit;
the snoop filter to identify the another encoded value in the snoop filter tag array and another corresponding state bit; the snoop filter to initiate a snoop of the cache if the another corresponding state bit is set;
wherein the snoop tag array is 1/Nth a size of the cache tag array, and N is at least 2.

16. The system of claim 15, wherein the state bit indicates there is a chance the physical address is owned by the cache if set and indicates the physical address is not owned by the cache if not set.

17. The system of claim 15, wherein the snoop filter further to initiate a refresh of a first portion of the snoop filter tag array and store refreshed data in a second portion of the snoop filter tag array, wherein if a new memory transaction is observed during the refresh, the snoop filter to check both the first portion and the second portion of the snoop filter tag array for the new encoded value of the new physical address to determine if the cache does not own the new physical address.

18. The system of claim 17, the snoop filter to further clear the first portion of the snoop filter tag array when the refresh is complete.

19. The system of claim 17, wherein the snoop filter to initiate the refresh when a number of set state bits exceeds a set threshold.

20. The system of claim 17, wherein the encoded value represents more than one physical address.
